(19) United States
(12) Patent Application Publication
(10) Pub. No.: US 2011/0143697 A1
(43) Pub. Date: Jun. 16, 2011

(54) SEPARATE I AND Q BASEBAND PREDISTORTION IN DIRECT CONVERSION TRANSMITTERS

(75) Inventors: Sumit Verma, San Diego, CA (US); Marco Cassia, San Diego, CA (US); Brian Clarke Banister, San Diego, CA (US)

(73) Assignee: QUALCOMM INCORPORATED, San Diego, CA (US)

(21) Appl. No.: 12/870,576

(22) Filed: Aug. 27, 2010

Related U.S. Application Data
(60) Provisional application No. 61/285,937, filed on Dec. 11, 2009.

(51) Int. Cl. H04B 1/04

(52) U.S. Cl. 455/114.3

(57) ABSTRACT

In-Phase (I) and Quadrature (Q) signals passing from a modem into a direct conversion transmitter are predistorted separately from, and independently of, one another. The I signal is predistorted to compensate for nonlinearities in the baseband I path circuitry between the modem and the upconverter. The Q signal is predistorted to compensate for nonlinearities in the baseband Q path circuitry between the modem and the upconverter. By employing the separate I and Q path baseband predistortion method, 4FMOD power in the upconverted and amplified signal as supplied to the transmitter antenna is reduced or eliminated. In one example, the transmitter employs single sideband modulation in the 777-787 MHz Verizon Band 13 while transmitting 23 dBm in a single LTE RB without emitting more than −57 dBm/6.25 kHz 4FMOD power into a nearby 763-775 MHz public safety band that starts only two megahertz away from the lower bound of Band 13.

### CROSS-REFERENCE TO RELATED APPLICATION

This application claims the benefit under 35 U.S.C. §119 of Provisional Application Ser. No. 61/285,937, filed Dec. 11, 2009, entitled “Base-Band Predistortion (BPD) Technique”, by Sumit Verma et al., said provisional application is incorporated herein by reference.

### BACKGROUND INFORMATION

1. Technical Field

The disclosed embodiments relate to predistortion and to direct conversion transmitters employing predistortion.

2. Background Information

FIG. 1 (Prior Art) is a very simplified diagram of a common direct conversion (I/Q) transmitter 1 such as is found in many cellular telephones. The block 2 labeled “modem” is a modulator/demodulator. This modem and Digital-to-Analog Converters (DACs) 3 and 4 are generally realized together in a digital baseband processor integrated circuit. The circuitry illustrated to the right of DACs 3 and 4 is RF (Radio Frequency) transceiver circuitry. This RF transceiver circuitry is generally realized in an RF transceiver integrated circuit. Modem 2 outputs two separate I and Q baseband signals in the form of two streams of digital values. These two signals pass into the two respective DACs. An I signal path extends from DAC 3, through a baseband filter 5, and to a first I input 6 of a quadrature mixer 7. A Q signal path extends from DAC 4, through a baseband filter 8, and to a second Q input 9 of the quadrature mixer 7. The baseband filters 5 and 8 are sometimes referred to together as the baseband filter of the transmit chain. The quadrature mixer 7 is also sometimes referred to as a quadrature upconverter. Quadrature upconverter 7 generates a signal 10 at higher RF frequencies. This RF signal 10 is amplified by power amplifier (PA) 11 into an amplified RF signal 12 that is then supplied onto an antenna 13 for transmission. The triangle labeled “RF AMP” 11 may, for example, involve a driver amplifier (DA) that is a part of the RF transceiver integrated circuit as well as a power amplifier (PA) that is realized in a separate integrated circuit.

In this example, the only signal to be output onto antenna 13 is a signal that is labeled “DESIRED SIGNAL” 14 in plot 15. Plot 15 is a plot of the spectral components of the signal output by the RF amplifier 11. The desired signal 14 in this simplified example is a single tone. It is to have a frequency offset with respect to a local oscillator signal LO 16 that drives the mixer 7. The local oscillator signal LO 16 is generated by a local oscillator 17. The local oscillator circuit that generates this signal 16 is also sometimes referred to as a frequency synthesizer. Unfortunately, the mixer 7 outputs, along with the desired signal 14, numerous undesired transmitter RF impairments. For example, in addition to the desired offset tone 14 there is also often an amount of LO leakage 18. This leakage 18 is represented by the label LO in plot 15. In addition, there is unwanted RSB 19 which is the IQ imbalanced image, as well as two spurs called “primary 4FMOD” and “secondary 4FMOD”. The primary 4FMOD signal 20 is due to the upconverted third harmonic 3BB of the baseband signal BB mixing with the LO signal. The secondary 4FMOD spur (not shown) is an image of the primary and is therefore much weaker. In frequency, the primary 4FMOD signal 20 is always on the other side of the LO signal 16, 18 from the desired signal 14. If the frequency difference between the LO signal 16,18 and the desired signal is denoted F, then the frequency difference between the desired signal 14 and the primary 4FMOD signal 20 is 4F. The primary 4FMOD signal is also sometimes referred to as a “counter IM3” signal.

Such a primary 4FMOD signal can be so strong that it becomes an unwanted emission. Specifically for Verizon Band 13, which is a 700 MHz band to be used for an early LTE (Long Term Evolution 4G) deployment in 2010, the particular primary 4FMOD signal 20 is an emission that falls in a protection band such as the public safety band. According to regulations, only a very low amount of power can be transmitted by the transmitter into this public safety band (−57 dBm/6.25 kHz). Meeting the stringent low emission requirements is very challenging due to the existence of the primary 4FMOD spur. The primary 4FMOD signal 20 is due to third order nonlinearities in the I and Q signal paths. In particular, the two low pass baseband filters 5 and 8 exhibit third order nonlinearities that manifest themselves as 4FMOD in RF signal 12. Even if an ideal and totally linear upconverter could somehow be used, the output of RF amplifier 11 would still contain 4FMOD components.

In FIG. 1, the plots 21, 22 and 15 illustrate the frequency components of the I signal at various locations in its signal path. If the signal I is a pure tone 23 as indicated by label BB in plot 21, then DAC 3 and baseband low pass filter 5 nevertheless introduce a third harmonic signal 24. This third harmonic signal 24 is denoted 3BB in plot 22. This 3BB signal 24 manifests itself as the primary 4FMOD signal 20 in the RF output signal 12. The ratio of the magnitude of the desired BB signal 23 to the 3BB signal 24 going into the upconverter is the same as the ratio of the desired signal 14 to the primary 4FMOD signal 20 coming out of the RF amplifier 11.

Predistortion is a technique for preventing unwanted frequency components from appearing in an output signal due to circuit nonlinearities. If for example the RF amplifier 11 at increased signal levels suffers from reduced gain, then RF predistortion can be employed to increase the amplitude of the signal as supplied to the RF transceiver to compensate such that the overall transmitter (from the input of the DACs of the transceiver to the output of the RF power amplifier) has a more linear input to output transfer function. The block 25 labeled RFPD in modem block 2 in FIG. 1 represents an RF predistorter operation.

FIG. 2 (Prior Art) is a diagram of the RF predistorter 25. A signal 26 as output by the modem 2 is carrying information in a Cartesian representation (I/Q). If this signal 26 were to be supplied directly to the RF transceiver, then substantial distortion would typically result due to nonlinearities such as the nonlinearity of the power amplifier as described above. To perform RF predistortion, the signal 26 is typically converted into a signal 27 in a phase and amplitude polar representation (Φ,A). This conversion is indicated by arrow 28 in FIG. 2.

FIG. 3 (Prior Art) is a diagram that shows how a point P in two-dimensional space can be represented by an I value and a Q value, where the I value indicates a displacement in the horizontal dimension and the Q value indicates a displacement in the vertical dimension. Point P is represented by the values (I1,Q1). This point P can, however, also be represented in polar representation by a vector of length A and a phase angle Φ, where the vector 29 originates at the origin and extends a length A to the point P. The length of this vector 29 is determined by geometry to be the square root of the sum of I1 squared plus Q1 squared. The phase angle Φ between the horizontal axis and the vector 29 is a phase angle Φ and is given be geometry to be arctan(Q1/I1). The relationship of FIG. 3 is used to convert the Cartesian representation of each point represented by the signals I and Q into a polar representation pair of signals Φ and A that carry the same information.

The resulting polar representation signal A is then predistorted by RF predistorter 25 based on the amplitude A. For example, if the RF power amplifier 11 suffers from reduced gain at high signal levels, then for high signal amplitudes A the RF predistorter 25 might increase the amplitude of the signal A to compensate for the low RF amplifier gain, whereas if the signal level is lower then RF amplifier 11 might not suffer from reduced gain such that the RF predistorter need not change the amplitude of the signal A. Optionally, the phase of the signal is also predistorted as a function of the phase to compensate for phase distortion. After this predistortion of the signal 27 by predistorter 25, the resulting signal 29 in the polar representation (Φ,A) is converted back to signal 30 in a Cartesian representation involving an I signal and a Q signal. This conversion is represented in FIG. 2 by arrow 31. The I signal is a stream of digital values. This stream of values is supplied to the input of DAC 3 of the I signal path. Similarly, the Q signal is a stream of digital values. The Q signal is supplied to the input of DAC 4 of the Q signal path. Ultimately, at the output of the RF amplifier 11, the transfer function of the RF signal 12 is linear with respect to the incoming I/Q signal 26. Unfortunately, despite performing such predistortion, the primary 4FMOD signal 20 may still be present in the RF output signal 12 at undesirable levels. FIG. 4 and FIG. 5 illustrate that the primary 4FMOD signal 20 manifests itself in the RF output signal regardless of whether the desired signal 14 is above or below the LO signal 16, 18 in frequency.

### SUMMARY

In-Phase (I) and Quadrature (Q) signals passing from a modem into a direct conversion transmitter are predistorted separately from, and independently of, one another. The I signal is predistorted to compensate for nonlinearities in the baseband I path circuitry between the modem and the upconverter. An example of the baseband I path circuitry is a Digital-to-Analog Converter (DAC) that receives a stream of I signal digital values from the modem and a baseband filter that filters the analog output of the DAC and supplies the resulting filtered I signal to an I-signal input of the upconverter. The Q signal is predistorted to compensate for nonlinearities in the baseband Q path circuitry between the modem and the upconverter. An example of the baseband Q path circuitry is a DAC that receives a stream of Q signal digital values from the modem and a baseband filter that filters the analog output of the DAC and supplies the resulting filtered Q signal to a Q-signal input of the upconverter. By employing the separate I and Q path baseband predistortion method, 4FMOD power in the upconverted and amplified RF signal as supplied to the transmitter antenna is reduced or eliminated. In one example, the transmitter employs single sideband modulation in the 777-787 MHz Verizon Band 13 and, while transmitting 23 dBm in a single LTE RB, the transmitter emits less than −57 dBm/6.25 kHz 4FMOD power into a nearby 763-775 MHz public safety band. The public safety band starts only two megahertz away from the lower bound of Band 13.

The foregoing is a summary and thus contains, by necessity, simplifications, generalizations and omissions of detail; consequently, those skilled in the art will appreciate that the summary is illustrative only and does not purport to be limiting in any way. Other aspects, inventive features, and advantages of the devices and/or processes described herein, as defined solely by the claims, will become apparent in the non-limiting detailed description set forth herein.

### BRIEF DESCRIPTION OF THE DRAWINGS

FIG. 1 (Prior Art) is a diagram of a direct conversion transmitter that has unwanted 4FMOD components in its transmitted output.

FIG. 2 (Prior Art) is a diagram of RF predistortion used in the direct conversion transmitter of FIG. 1.

FIG. 3 (Prior Art) is a diagram that illustrates how information output by the modem in the transmitter of FIG. 1 can be represented in a Cartesian representation or in a polar representation.

FIG. 4 (Prior Art) illustrates the location of the primary 4FMOD signal in a situation in which the local oscillator signal is below the desired signal in frequency.

FIG. 5 (Prior Art) illustrates the location of the primary 4FMOD signal in a situation in which the local oscillator signal is above the desired signal in frequency.

FIG. 6 a diagram of a communication system 100 involving a direct conversion transmitter in accordance with one novel aspect. The system 100 employs a separate I and Q path baseband predistortion method 200 in accordance with one novel aspect.

FIG. 7 is a more detailed diagram of the RF transceiver integrated circuit 102 and antenna 103 of FIG. 6.

FIG. 8 is a simplified diagram of the system 100 of FIG. 6 and FIG. 7 showing signal flow and processing in the digital baseband processor IC 101 in further detail.

FIG. 9 is a diagram that shows plots 141, 142, 143 of the I signal at various points as the I signal passes in a signal path from the modem within the digital baseband integrated circuit 101, through the I signal path 134, through the quadrature upconverter 118, through the RF amplifier 119,114, and to antenna 103.

FIG. 10 is a diagram that illustrates an operation of the separate I and Q path baseband predistortion method 200 described above in connection with FIG. 8 and FIG. 9.

FIG. 11 is a flowchart of the separate I and Q path baseband predistortion method 200 described above in connection with FIG. 8 and FIG. 9.

### DETAILED DESCRIPTION

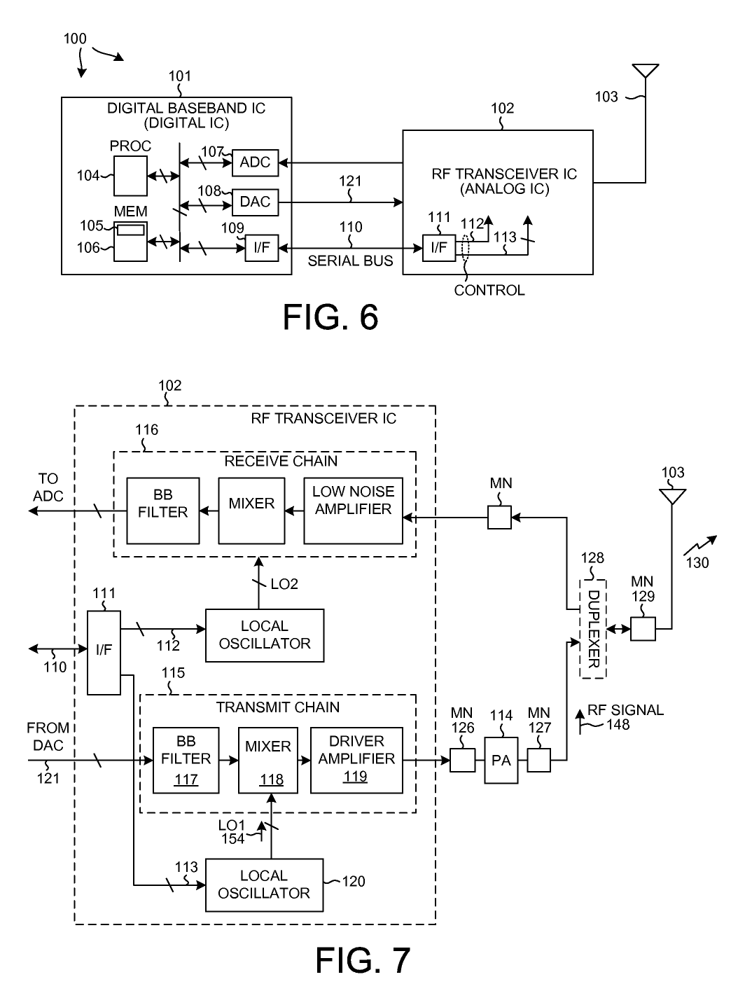

FIG. 6 is a diagram of a communication system 100 that employs a separate I and Q path baseband predistortion method in accordance with one novel aspect. System 100 in this example is a cellular telephone handset involving (among other parts not illustrated) a digital baseband processor integrated circuit 101, an RF transceiver integrated circuit 102, and an antenna 103. Digital baseband processor integrated circuit 101 includes a digital processor 104 that executes a program 105 of processor-executable instructions. Program 105 is stored in a processor-accessible processor readable medium 106 such a semiconductor memory. The processor 104 can receive incoming data from ADC block 107 and can output outgoing data to DAC block 108. Processor 104 and program 105 also together realize a modem (modulator/demodulator) functionality. Processor 104 controls the transmit and receive functionalities of RF transceiver integrated circuit 102 by sending appropriate control information to integrated circuit 102 via serial bus interface block 109, serial bus 110, serial bus interface block 111, and control conductors 112 and 113.

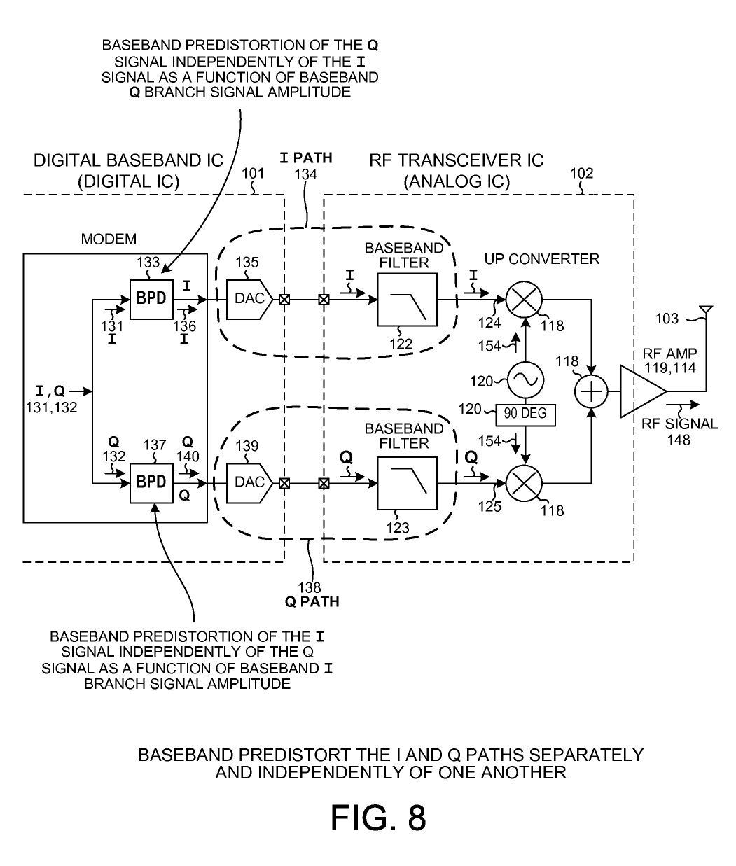

FIG. 7 is a more detailed diagram of the RF transceiver integrated circuit 102, antenna 103, and intervening circuitry including a discrete power amplifier (PA) integrated circuit 114. The RF transceiver integrated circuit 102 includes direct conversion (I/Q) transmit chain 115 and a receive chain 116. Transmit chain 115 includes a baseband filter block 117, a quadrature upconverter 118 (also referred to as a quadrature mixer), and a driver amplifier 119. A local oscillator circuit 120 (also referred to as a frequency synthesizer) supplies a quadrature local oscillator signal (LO1) 154 to mixer 118. When the cellular telephone 100 is transmitting, a baseband signal involving an I signal and a Q signal is generated in digital baseband processor integrated circuit 101. Signal I is a first stream of digital values and signal Q is a second stream of digital values. After being converted into analog form by a pair of DACs inside DAC block 108, the resulting analog I signal and the resulting analog Q signal are supplied across conductors 121 to base band filter block 117. Baseband filter block 117 actually includes two base band filters 122 and 123 (see FIG. 8). Filter 122 is for the I signal. Filter 123 is for the Q signal. The I signal as output from the I baseband filter 122 is supplied onto a first input 124 of the quadrature upconverter 118 (see FIG. 8), whereas the Q signal as output from the Q baseband filter 123 is supplied onto a second input 125 of the quadrature upconverter 118. As illustrated in FIG. 7, the output of the quadrature upconverter 118 is amplified by driver amplifier (DA) 119 and is output from the RF transceiver integrated circuit 102. The RF signal passes through matching network 126, and is further amplified by RF power amplifier (PA) 114. The resulting amplified signal 148 passes through matching network 127 and duplexer 128 and matching network 129 and is driven out onto antenna 103 and is transmitted from device 100 as RF signal 130. The direct conversion transmitter is tuned by controlling the frequency of the local oscillator signal LO1 154.

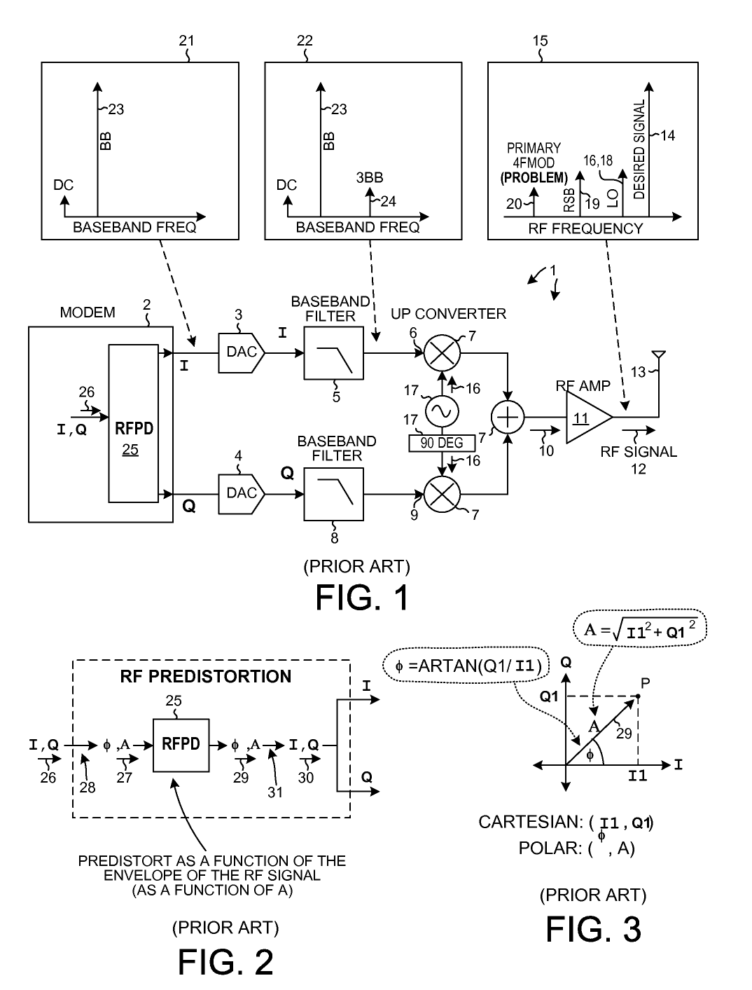

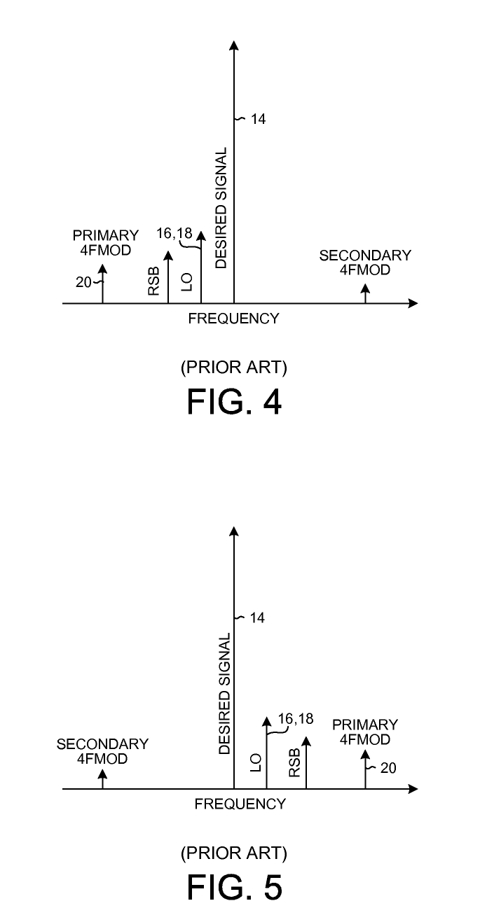

FIG. 8 is a simplified diagram of the system 100 of FIG. 6 and FIG. 7 showing signal flow and processing in the digital baseband IC 101 in further detail. Rather than performing RF predistortion on the polar representation of the I/Q signal as explained above in connection with FIG. 1 (Prior Art) and FIG. 2 (Prior Art), the original I and Q signals 131 and 132 as output by the modem are predistorted separately and independently as indicated in FIG. 8.

In the example of FIG. 8, the I and Q signals 131 and 132 are narrow bandwidth (one or two LTE RBs wide) single sideband modulated signals. I signal predistorter 133 may be a LUT or polynomial predistorter that inverts I path nonlinearity as a function of the baseband I path signal amplitude only. The label BPD in block 133 indicates baseband predistortion. Baseband predistorter 133 performs baseband predistortion on the I signal 131 to compensate for baseband nonlinearities in the I signal path 134 separate and apart from any nonlinearities that might or might not exist at baseband frequencies in the Q signal path and separate and apart from any nonlinearities that might or might not exist at RF frequencies in the RF amplifier. The I signal path 134 includes DAC 135 and baseband filter 122. The predistorted I signal 136 as output from predistorter 133 is a predistorted stream of I values supplied to DAC 135.

Similarly, Q signal predistorter 137 may be a LUT or polynomial predistorter that inverts Q path nonlinearity as a function of the baseband Q path signal amplitude only. The label BPD in block 137 indicates baseband predistortion. Baseband predistorter 137 performs baseband predistortion on the Q signal 132 to compensate for baseband nonlinearities in the Q signal path 138 separate and apart from any nonlinearities that might or might not exist at baseband frequencies in the I signal path and separate and apart from any nonlinearities that might or might not exist at RF frequencies in the RF amplifier. The Q signal path 138 includes DAC 139 and baseband filter 123. The predistorted Q signal 140 as output from predistorter 137 is a predistorted stream of Q values supplied to DAC 139. DACs 135 and 139 of FIG. 8 are within block 108 of FIG. 6.

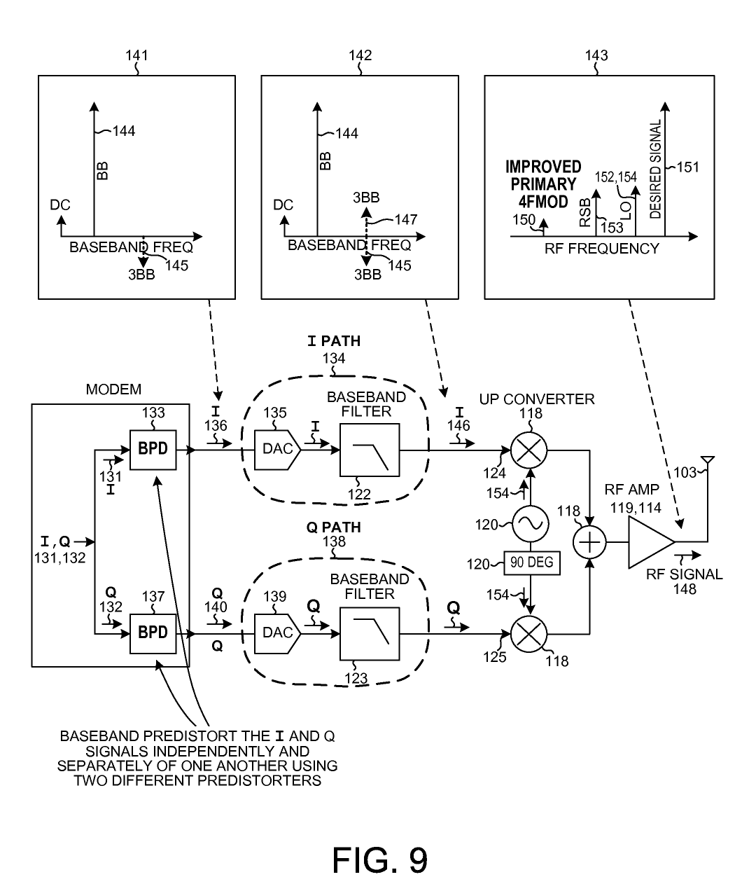

FIG. 9 is a diagram that shows plots 141, 142, 143 of the I signal at various points as the I signal passes from the modem within the digital baseband integrated circuit 101, through the I signal path 134, through the quadrature upconverter 118, through the RF amplifier 119,114, and to antenna 103. Although corresponding plots are not shown for the Q signal, the Q signal is processed as the I signal is except that the Q signal is predistorted to account for nonlinearities in the Q path as opposed to being predistorted to account for nonlinearities in the I path.

Plot 141 is a frequency diagram that shows the spectral components of the predistorted I signal 136 as output by I predistorter 133. The I signal as output from the I signal predistorter 133 has, not only the desired baseband signal 144 that is denoted BB in the plot, but also has an additional predistortion component 145 denoted 3BB in the plot. The predistortion component is indicated by the downward pointing arrow 145.

Plot 142 is a frequency diagram that shows the spectral components of the I signal 146 as output by baseband filter 122 onto the I input 124 of quadrature mixer 118. The I signal path 134 involving DAC 135 and baseband filter 122 introduces a third order nonlinearity as represented by upward pointing arrow 147. This third order nonlinearity is, however, canceled by the predistortion component 145. In another representation, there are no arrows 147 or 145 in the plot 142 because the two arrows represent signals that cancel one another. The two arrows are shown in plot 142 for illustrative and instructional purposes.

Plot 143 is a frequency diagram that shows the spectral components in the RF amplifier output signal 148. The 4FMOD spur 150 is of a much lower amplitude than in the prior art situation represented by plot 15 in FIG. 1. In plot 143, arrow 151 represents the desired signal. Arrow 152 represents LO leakage. Arrow 153 represents the IQ imbalanced image RSB. If the frequency difference between the LO signal 154,152 and the desired signal 151 is denoted F, then the frequency difference between the desired signal 151 and the primary 4FMOD signal 150 is 4F. The primary 4FMOD signal 150 is also sometimes referred to as the “counter IM3” signal.

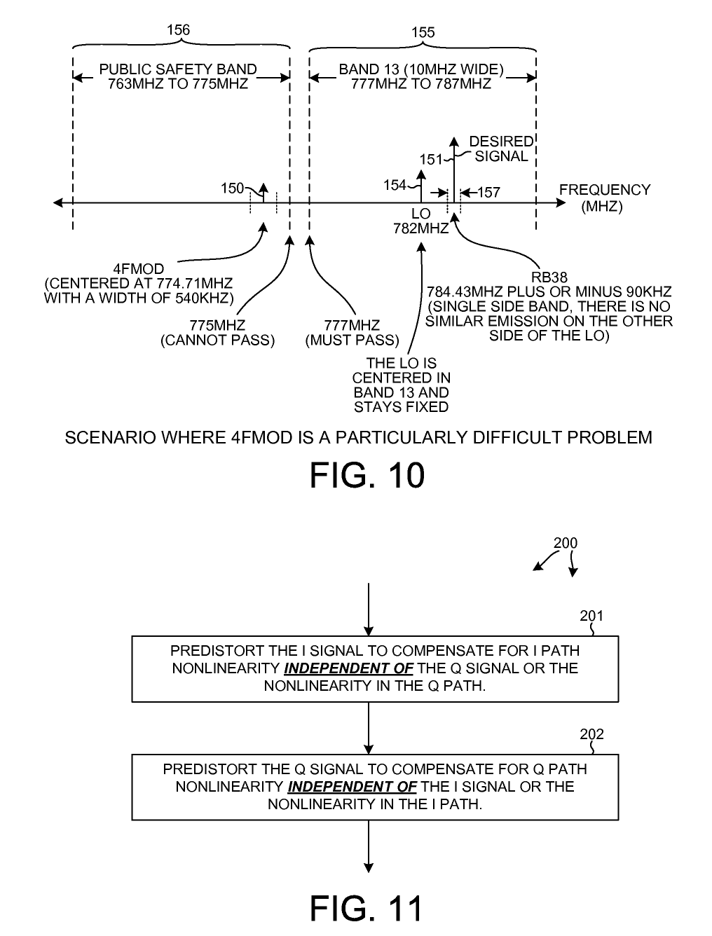

FIG. 10 is a diagram that illustrates an operation of the separate I and Q path baseband predistortion described above in connection with FIG. 9. The scenario is a scenario where 4FMOD is a particularly difficult problem. Verizon Band 13 155 is 10 MHz wide and extends from 777 MHz to 787 MHz. LTE resource blocks (RBs) can be allocated in this band. Each resource block is 180 kHz wide and there can be up to fifty adjacent resource blocks allocated designated RB1 to RB50. In addition to Verizon Band 13, there is a public safety band 156 that extends from 763 MHz to 775 MHz. Only 2 MHz separates the 777 MHz lower bound of Band 13 and the 775 MHz upper bound of the public safety band. The baseband filters 122 and 123 are therefore be made to pass signals that would be upconverted to be at the 777 MHz boundary of Band 13. Due to the small 2 MHz that separates the relatively wide Band 13 and the upper 775 MHz boundary of the public safety band, a filter cannot be effectively used to filter 4FMOD components out of the power amplifier output signal before the signal is transmitted from the antenna. As illustrated, the local oscillator signal LO 154 is centered in Band 13 and remains fixed at 782 MHz even though the transmitter may be required to transmit in various different resource blocks. In one example, the direct conversion transmitter is made to transmit in resource block RB38 157. Resource block RB38 is at 784.43 MHz, plus or minus 90 kHz. Accordingly, the transmitter uses single sideband modulation to transmit into RB38 and not into another resource block despite the LO signal 154 being centered at 782 MHz. Under these conditions, the 4FMOD signal is centered at 774.71 MHz and has a width of 540 kHz. In accordance with one novel aspect, in an LTE (Long Term Evolution 4G) implementation, separate I and Q path baseband predistortion as described in connection with FIG. 8 and FIG. 9 is used successfully to limit the magnitude of the 4FMOD signal to below −57 dBm/6.25 kHz.

FIG. 11 is a simplified flowchart of the novel separate I and Q path baseband predistortion method 200. In step 201, the I signal 131 as generated by the modem is predistorted to compensate for 1 path nonlinearities, and is not done to compensate for any nonlinearities that might or might not exist in the Q signal path or to compensate for any nonlinearities that might or might not exist in the RF amplifier. This I path baseband predistortion is done as a function of I signal amplitude. In the example of FIG. 9, the I path is I path 134 and includes DAC 135 and baseband filter 122. In step 202, the Q signal 132 as generated by the modem is predistorted to compensate for Q path nonlinearities, and is not done to compensate for any nonlinearities that might or might not exist in the I signal path or to compensate for any nonlinearities that might or might not exist in the RF amplifier. This Q path baseband predistortion is done as a function of Q signal amplitude. In the example of FIG. 9, the Q path is Q path 138 and includes DAC 139 and baseband filter 123. The I and Q signals as predistorted are then supplied to two inputs 124 and 125 of quadrature upconverter 118 in a direct conversion (I/Q) transmitter.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. In one specific example, memory 106 of FIG. 6 is a processor-readable medium that stores a set of processor-readable and processor-executable instructions 105. Processor 104 reads and executes the processor-executable instructions, thereby causing the method 200 of FIG. 11 to be carried out. The processor may be, or may include, a digital signal processor (DSP). The processor may include an amount of special dedicated hardware that performs some selected amount of the processing in hardware rather than in software or firmware.

Although certain specific embodiments are described above for instructional purposes, the teachings of this patent document have general applicability and are not limited to the specific embodiments described above. Accordingly, various modifications, adaptations, and combinations of the various features of the described specific embodiments can be practiced without departing from the scope of the claims that are set forth below.

What is claimed is:

1. A method comprising:
predistorting a first In-Phase (I) signal and thereby generating a second I signal, wherein the predistorting of the first I signal predistorts to compensate for nonlinearities in an I signal path of a direct conversion transmitter, and wherein the predistorting of the first I signal predistorts substantially independently of nonlinearities in a Q signal path of the direct conversion transmitter;
predistorting a first Quadrature (Q) signal and thereby generating a second Q signal, wherein the predistorting of the first Q signal predistorts to compensate for the nonlinearities in the Q signal path, and wherein the predistorting of the Q signal predistorts substantially independently of the nonlinearities in the I signal path;
passing the second I signal through the I signal path; and
passing the second Q signal through the Q signal path.

2. The method of claim 1, wherein neither the predistorting of the first I signal nor the predistorting of the first Q signal is a predistorting as a function of a complex envelope of any complex signal.

3. The method of claim 1, wherein an RF (Radio Frequency) amplifier of the direct conversion transmitter has nonlinearities, wherein the predistorting of the first I signal is not a predistorting that compensates for the nonlinearities in the RF amplifier, and wherein the predistorting of the first Q signal is not a predistorting that compensates for the nonlinearities in the RF amplifier.

4. The method of claim 2, wherein the predistorting of the first I signal involves using a first predistorter to generate the second I signal, and wherein the predistorting of the first Q signal involves using a second predistorter to generate the second I signal.

5. The method of claim 2, wherein the predistorting of the first I signal involves using a first Look Up Table (LUT) to generate the second I signal, and wherein the predistorting of the first Q signal involves using a second LUT to generate the second I signal.

6. The method of claim 2, wherein the predistorting of the first I signal involves using a first polynomial-based predistorter to generate the second I signal, and wherein the predistorting of the first Q signal involves using a second polynomial-based predistorter to generate the second I signal.

7. The method of claim 1, wherein the nonlinearities in the I and Q signal paths differ from one another.

8. The method of claim 1, wherein the I signal path involves a first Digital-to-Analog Converter (DAC) and a first baseband filter, and wherein the Q signal path involves a second DAC and a second baseband filter.

9. The method of claim 1, wherein the first I signal and the first Q signal are narrow bandwidth single sideband modulated signals.

10. An apparatus comprising:
a direct conversion transmitter having an I signal path and a Q signal path, wherein the I signal path has first nonlinearities, and wherein the Q signal path has second nonlinearities;
a first predistorter that receives a first In-Phase (I) signal, performs a first predistortion operation to compensate for the first nonlinearities in the I signal path, and supplies a second I signal onto an input of the I signal path of the direct conversion transmitter, wherein the first predistortion operation predistorts substantially independently of the second nonlinearities in the Q signal path; and
a second predistorter that receives a first Quadrature (Q) signal, performs a second predistortion operation to compensate for the second nonlinearities in the Q signal path, and supplies a second Q signal onto an input of the Q signal path of the direct conversion transmitter, wherein the second predistortion operation predistorts substantially independently of the first nonlinearities in the I signal path.

11. The apparatus of claim 10, wherein neither the first predistortion operation nor the second predistortion operation is a predistorting as a function of a complex envelope of any complex signal.

12. The apparatus of claim 10, wherein the direct conversion transmitter includes an RF (Radio Frequency) amplifier, wherein the predistorting of the first I signal is not a predistorting that compensates for nonlinearities in the RF amplifier, and wherein the predistorting of the first Q signal is also not a predistorting that compensates for nonlinearities in the RF amplifier

13. The apparatus of claim 10, wherein the input of the I signal path of the direct conversion transmitter is an input of a first Digital-to-Analog Converter (DAC), and wherein the input of the Q signal path of the direct conversion transmitter is an input of a second DAC.

14. The apparatus of claim 10, wherein the first predistorter is a first Look Up Table (LUT), and wherein second predistorter is a second LUT.

15. The apparatus of claim 10, wherein the first predistorter is a first polynomial-based predistorter, and wherein the second predistorter is a second polynomial-based predistorter.

16. The apparatus of claim 10, wherein the first I signal and the first Q signal are narrow bandwidth single sideband modulated signals

17. An apparatus comprising:
a direct conversion transmitter having an I signal path and a Q signal path, wherein the I signal path has first nonlinearities, and wherein the Q signal path has second nonlinearities; and
means for receiving a first In-Phase (I) signal, for performing a first predistortion operation to compensate for the first nonlinearities in the I signal path, and for supplying a second I signal onto an input of the I signal path of the direct conversion transmitter, wherein the first predistortion operation predistorts substantially independently of the second nonlinearities in the Q signal path, wherein the means is also for receiving a first Quadrature (Q) signal, for performing a second predistortion operation to compensate for the second nonlinearities in the Q signal path, and for supplying a second Q signal onto an input of the Q signal path of the direct conversion transmitter, wherein the second predistortion operation predistorts substantially independently of the first nonlinearities in the I signal path.

18. The apparatus of claim 17, wherein the direct conversion transmitter includes an RF (Radio Frequency) amplifier, wherein the first predistortion operation does not compensate for nonlinearities in the RF amplifier, and wherein the second predistortion operation does not compensate for nonlinearities in the RF amplifier.

19. The apparatus of claim 17, wherein the means is a part of a digital baseband processor integrated circuit, wherein the I signal path includes a first Digital-to-Analog Converter (DAC) of the digital baseband processor integrated circuit as well as a first baseband filter that is a part of an RF transceiver integrated circuit, and wherein the Q signal path includes a second DAC of the digital baseband processor integrated circuit as well as a second baseband filter that is a part of the RF transceiver integrated circuit.

20. The apparatus of claim 17, wherein the means comprises a processor that executes a set of processor-executable instructions.

21. The apparatus of claim 17, wherein neither the first predistortion operation nor the second predistortion operation is a predistorting as a function of a complex envelope of any complex signal.

22. A processor-readable medium storing a set of processor-executable instructions, wherein execution of the set of processor-executable instructions by a processor is for:
predistorting a first In-Phase (I) signal and thereby generating a second I signal, wherein the predistorting of the first I signal predistorts to compensate for nonlinearities in an I signal path of a direct conversion transmitter, and wherein the predistorting of the first I signal predistorts substantially independently of nonlinearities in a Q signal path of the direct conversion transmitter;
predistorting a first Quadrature (Q) signal and thereby generating a second Q signal, wherein the predistorting of the first Q signal predistorts to compensate for the nonlinearities in the Q signal path, and wherein the predistorting of the Q signal predistorts substantially independently of the nonlinearities in the I signal path;
supplying the second I signal onto an input of the I signal path; and
supplying the second Q signal onto an input of the Q signal path.

23. The processor-readable medium of claim 22, wherein the processor-readable medium is a memory that is a part of a digital baseband processor integrated circuit, wherein the digital baseband processor integrated circuit further comprises the processor, a Digital-to-Analog Converter (DAC) of the I signal path, and a DAC of the Q signal path.

24. The processor-readable medium of claim 22, wherein neither the predistorting of the first I signal nor the predistorting of the first Q signal is a predistorting as a function of a complex envelope of any complex signal.

25. The processor-readable medium of claim 22, wherein the direct conversion transmitter includes an RF (Radio Frequency) amplifier, wherein neither the predistorting of the first I signal nor the predistorting of the first Q signal is a predistorting that compensates for nonlinearities of the RF amplifier.
